(19) United States
(12) Patent Application Publication
(10) Pub. No.: US 2005/0192056 A1
(43) Pub. Date: Sep. 1, 2005

(54) Method and apparatus for connecting/disconnecting wireless-connection to network

(75) Inventor: Isuke Karaki, Yokohama-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/058,313

(22) Filed: Feb. 16, 2005

(30) Foreign Application Priority Data
Feb. 17, 2004 (JP) 2004-040077
Jan. 25, 2005 (JP) 2005-017075

(51) Int. Cl. H04Q 7/20; H04B 7/00

(52) U.S. Cl. 455/561; 455/507; 455/456.1

(57) ABSTRACT

A base station has a wireless communication unit for wirelessly communicating with a wireless terminal; means for connecting to and disconnecting from a wireless network; a storage unit for storing service area information defining a service area around the base station, the wireless terminal located inside the service area being allowed to connect to the network via the wireless communication unit of the base station; a measuring unit for measuring the location of a wireless terminal; first determining means for determining whether a wireless terminal is located in the service area around the base station on the basis of the location of the wireless terminal measured by the measuring unit; connecting means for connecting a wireless terminal to the network via the base station in a case that the wireless terminal is determined by the first determining means to be located in the service area around the base station; monitoring means for monitoring the location of the wireless terminal which is connected to the network by the connecting means; second determining means for determining whether the wireless terminal monitored by the monitoring means is located inside the service area; and means for disconnecting a connection from a wireless terminal to the network via the wireless communication unit of the base station in a case that the wireless terminal is determined by the second determining means to be located outside the service area.

### BACKGROUND OF THE INVENTION

1. Field of the Invention

The present invention relates to a method and an apparatus for connecting to and disconnecting from a wireless network.

2. Description of the Related Art

Recently, it has become increasingly common to use electronic meeting systems where wireless terminals are installed in meeting rooms or the like.

A patent publication JP 2003-A-085112 discloses an example of such an electronic meeting system. The electronic meeting system includes a local area network (LAN), a wireless terminal(s), an access point (this will be referred as ‘AP’), and a projector connected to the LAN. The AP provides a wireless terminal with a wireless connection to the LAN.

When a meeting is held in a meeting room, a person (s/he will be referred to as an ‘attendee’) may carry a wireless terminal storing data for a presentation. The attendee accesses the LAN via the AP to join the electronic meeting system to make their presentation. The data is then transferred from the wireless terminal to the projector via the LAN, and the presentation data is projected onto the screen by the projector. The attendee may also access other available resources on the LAN. When accessing the electronic meeting system, the attendee is required to input a password. When leaving the meeting room, the attendee is required to disconnect manually from the LAN so as to withdraw from the electronic meeting system.

A patent publication JP 2003-A-333559 discloses another example of such an electronic meeting system. The electronic meeting system also includes a LAN, a host computer, an AP, a wireless terminal(s), and a projector connected to the LAN. Similarly to the first example, an attendee is required to input a password to access an electronic meeting system from a wireless terminal such as a PC (Personal Computer). In this example, the host computer generates a meeting-specific password for each meeting, and displays the generated password on a screen by controlling the projector. The attendee inputs the displayed password. Once the password is input, the attendee can access the electronic meeting system from their wireless terminal to exchange data relating to the meeting with other stations.

In both of the foregoing examples, it may be possible to access the electronic meeting system from outside a meeting room via the AP, since the radio signals tend to diminish gradually as a distance from the meeting room increases. Accordingly, an attendee may be able to access the electronic meeting system even after leaving the meeting room.

Furthermore, an attendee of a meeting may remain in a region outside the meeting room, after leaving the meeting room and intentionally leaving their PC connected to the electronic meeting system. The attendee may then intercept information exchanged via the electronic meeting system. For example, after attending a board meeting held in a meeting room to explain a proposal using the electronic meeting system, an employee is able to intercept confidential information in the board meeting from a region outside the meeting room.

### SUMMARY OF THE INVENTION

The present invention has been made in view of the above circumstances and provides a method and apparatus for connecting to and disconnecting from a wireless network.

According to an aspect of the present invention, the base station has
a wireless communication unit for wirelessly communicating with a wireless terminal; means for connecting to disconnecting from a network; a storage unit for storing service area information defining a service area around the base station, the wireless terminal located inside the service area being allowed to connect to the network via the wireless communication unit of the base station; a measuring unit for measuring the location of a wireless terminal; first determining means for determining whether a wireless terminal is located in the service area around the base station on the basis of the location of the wireless terminal measured by the measuring unit; connecting means for connecting a wireless terminal to the network via the base station in a case that the wireless terminal is determined by the first determining means to be located in the service area around the base station; monitoring means for monitoring the location of the wireless terminal which is connected to the network by the connecting means; second determining means for determining whether the wireless terminal monitored by the monitoring means is located inside the service area; and means for disconnecting a connection from a wireless terminal to the network via the wireless communication unit of the base station in a case that the wireless terminal is determined by the second determining means to be located outside the service area.

According to an aspect of the present invention, a wireless communication network has the base station described above.

Accordingly, the base station connects a wireless terminal to a network via the base station only in a case that the wireless terminal is located in the service area. Thus, in an exemplary case that the service area is set inside a meeting room, after an attendee leaves the meeting room carrying their wireless terminal, they can no longer use the wireless terminal to access information exchanged in the meeting held in the meeting room.

According to an aspect of the present invention, the base station further has means for setting-up transmitting characteristics of the wireless communication unit of the base station on the basis of the service area information stored in the storage unit. Accordingly, the transmitting characteristics including transmitting power may be set-up on the basis of shape and size of a service area and the location of a base station in the service area. Thus an area covered by radio signals transmitted from a base station may be kept as small as possible while still enabling communication with wireless terminals in the service area around the base station. Namely, a spillover area outside the service area may be kept as small as possible.

According to an aspect of the present invention, the wireless communication unit of the base station transmits a message to a wireless terminal in accordance with the transmitting characteristics set up by the setting-up means, and the measuring unit of the base station measures the location of a wireless terminal only in a case of receiving a response to the message from the wireless terminal within a predetermined time.

According to an aspect of the present invention, the method is performed by a base station and has the steps of: measuring a location of a wireless terminal; first determining whether a wireless terminal is located in a service area of the base station on the basis of the location of the wireless terminal measured in the measuring step;
connecting a wireless terminal to a network via the base station in a case that the wireless terminal is determined to be located in the service area in the first determining step;
monitoring the location of the wireless terminal connected to the network in the connection step;
second determining whether a wireless terminal is located in the service area of the base station on the basis of the location of the wireless terminal monitored in the monitoring step;
disconnecting a connection from a wireless terminal to the network via the base station in a case that the wireless terminal is determined to be located outside the service area in the second determining step.

According to an aspect of the present invention, a computer program product enables a computer of a base station to perform the processes of: measuring a location of a wireless terminal; first determining whether a wireless terminal is located in a service area of the base station on the basis of the location of the wireless terminal measured in the measuring process; connecting a wireless terminal to a network via the base station in a case that the wireless terminal is determined to be located in the service area in the first determining process; monitoring the location of the wireless terminal connected in the connecting process; second determining whether a wireless terminal is located in the service area of the base station on the basis of the location of the wireless terminal monitored in the monitoring process; disconnecting a connection from a wireless terminal to the network via the base station in a case that the wireless terminal is determined to be located outside the service area in the second determining process.

According to an aspect of the present invention, the above computer program product is stored in the computer-readable storage medium.

### BRIEF DESCRIPTION OF THE DRAWINGS

FIG. 1 illustrates an overview of a communication system according to an embodiment of the present invention.

FIG. 2 is a functional block diagram of Access Point (AP) 40.

FIG. 3 illustrates a structure of antenna 405a.

FIG. 4 illustrates radio wave emission characteristics of antenna 405a.

FIG. 5 illustrates template data 406a, each indicating a shape of a meeting room.

FIG. 6 illustrates location map 406b.

FIG. 7 illustrates management table 406c.

FIG. 8 illustrates relations between reception levels of radio signals at wireless terminal 60 and distances from wireless terminals.

FIGS. 9 and 10 are flowcharts illustrating operations of AP40.

### DETAILED DESCRIPTION OF THE INVENTION

Details of the present invention will be described with reference to the attached drawings.

### A. Configuration

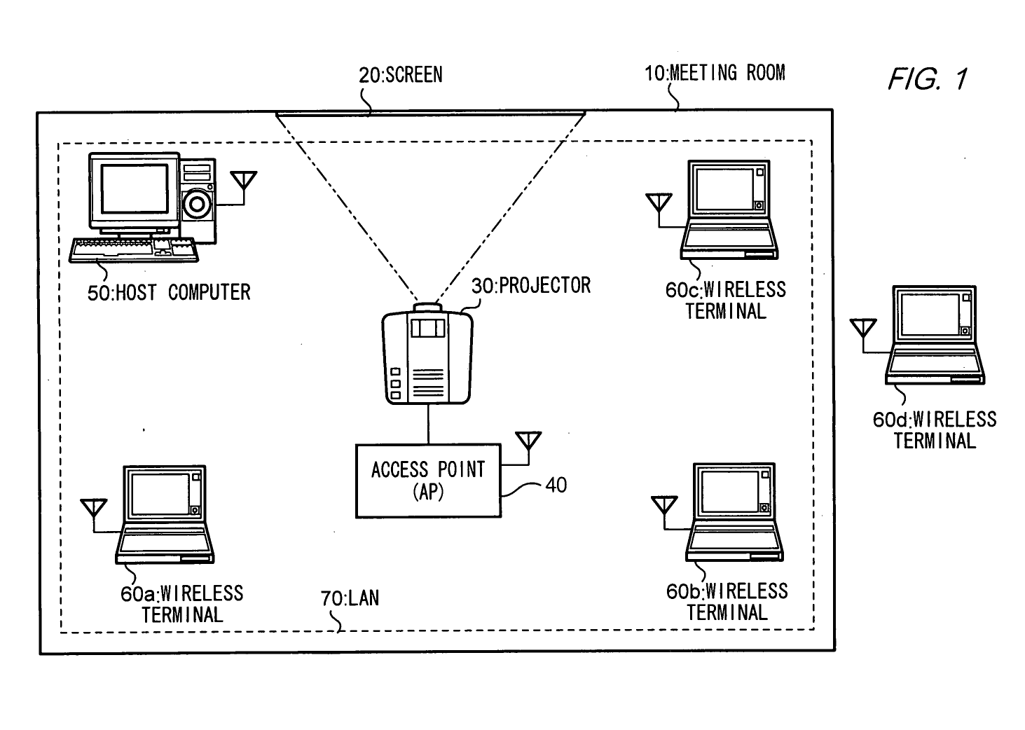

FIG. 1 illustrates an overview of a communication system according to an embodiment of the present invention.

In the present embodiment, LAN 70 includes an access point 40 (this will also be referred as “AP40”), wireless terminals 60a-60c located in meeting room 10, a host computer 50, and a network connectable projector 30, as illustrated in FIG. 1.

As illustrated in FIG. 1, an access point 40 is situated in a meeting room 10. A plurality of access points 40 may be placed in meeting room 10. Access point 40 provides wireless terminal 60a-60c located in meeting room 10 with a wireless connection to LAN 70.

A projector 30 and a screen 20 for projecting images thereon are also placed in meeting room 10. As illustrated in FIG. 1, projector 30 is connected to AP40 with a cable. Projector 30 may also be connected to AP40 wirelessly.

Host computer 50 is detachably connected to LAN70, and provides a function of setting parameters in AP40.

Although the communication system is installed in meeting room 10 in the example illustrated in FIG. 1, the present communication system may be installed throughout a whole floor of a building, an entire building, or the like.

Wireless terminal 60a-60d will be simply referred as “wireless terminal 60” later, where no distinction is required.

Wireless terminal 60 is configured, for example, as a notebook type personal computer equipped with a wireless LAN interface card, and may store presentation data including image and document data. Wireless terminal 60 may be configured as a PDA (Personal Digital Assistant) having a wireless communication function or as a mobile phone accommodated in a base station of a mobile communication system.

The presentation data, stored in the wireless terminal 60 carried into meeting room 10 by an attendee, may be transferred to projector 30 for presentation, when the wireless terminal 60 is connected to LAN70 via AP40. The attendee may exchange data via LAN70 with wireless terminals of other attendees.

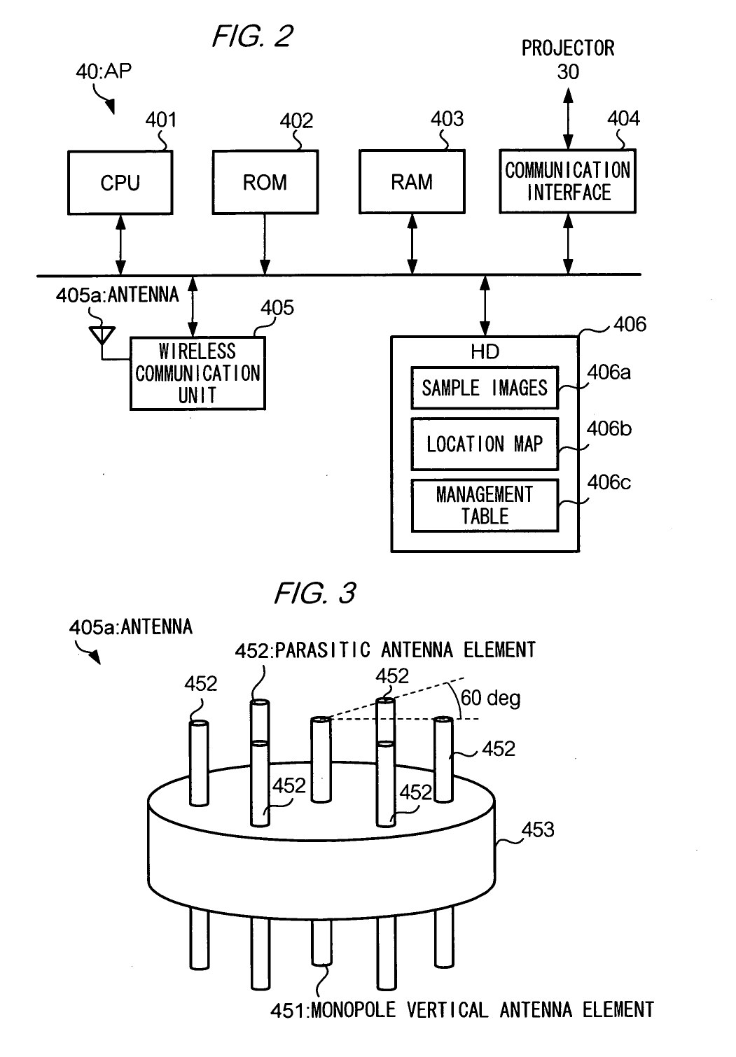

FIG. 2 illustrates a functional block diagram of AP40.

CPU401 executes computer programs stored in ROM402 and/or hard disk drive HD406 so as to control AP40. ROM402 stores programs and data for controlling AP40. RAM403 is used as a working area of CPU401. Communication interface 404 handles communications with projector 30.

Wireless communication unit 405 has an antenna 405a and a high-frequency transmission/reception circuit including an amplifier(s) and a frequency converter(s), and handles wireless communications with wireless terminal 60.

Antenna 405a includes, as illustrated in FIG. 3, a vertical monopole antenna element 451 disposed in a center, and six parasitic antenna elements 452 disposed around vertical monopole antenna element 451 at 60 degree intervals. The antenna may be an ESPA antenna (Electronically Steerable Parasitic Array Radiator Antenna) developed by Wave Engineering Laboratories.

Vertical monopole antenna element 451 is directly connected to the high-frequency transmission/reception circuit of wireless communication unit 405, whereas each parasitic antenna element 452 is grounded via a resistive element such as a variable capacitance diode. According to the configuration, antenna 405a requires only one high-frequency transmission/reception circuit. Thus, the construction cost and the power consumption of AP40 may be reduced in comparison to other configurations such as active phased array antenna.

Wireless communication unit 405 may change electromagnetic coupling between vertical monopole antenna element 451 and each parasitic antenna element 452 by changing resistances of the resistive element connected to each parasitic antenna elements 452, so as to change the propagation direction and pattern of a radio wave emitted from antenna 405a.

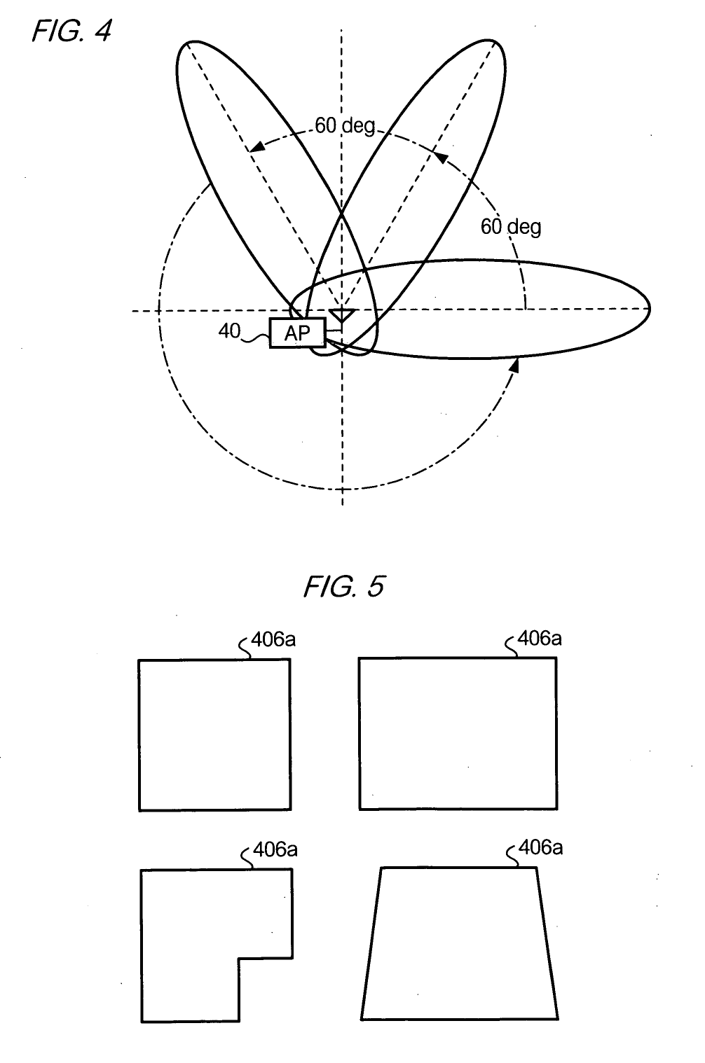

For example, wireless communication unit 405 may change the propagating direction of a radio wave emitted from antenna 405a at 60 degree intervals as illustrated in FIG. 4, and control the transmission power so that the radio wave might propagate a prescribed distance in the direction.

Details of antenna 405a are described, for example in “Scanning Electron Guide Array Antenna”, by Takashi Ohira, et. al. in IEICE Journal J87-C, 1, pp. 12-31, 2004-01.

The configuration of antenna 405a may be modified, for example, in the number of parasitic antenna elements 452, and is not limited to the example illustrated in FIG. 3. For example eight parasitic antenna elements 452 may be disposed around vertical monopole antenna element 451 at 45 degree intervals, or twelve parasitic antenna elements 452 may be disposed around vertical monopole antenna element 451 at 30 degree intervals.

HD406 stores a SSID (Service Set Identifier) assigned to each AP40, a meeting-specific password for each meeting, and identification information of one or a plurality of wireless terminal(s) 60. Identification information of wireless terminal 60 is uniquely assigned to each wireless terminal 60 to identify it in LAN70 and includes a MAC address or a nickname.

HD406 stores a plurality of template data 406a as illustrated in FIG. 5, data of each template indicating a shape of a service area, inside which wireless terminal 60 may connect to LAN70 via AP40. In the present embodiment, data of each template defines an outline of meeting room 10.

HD406 stores location map 406b and management table 406c, both of which are used to manage locations of wireless terminals 60 which are located inside meeting room 10 and connected to LAN70 via AP40.

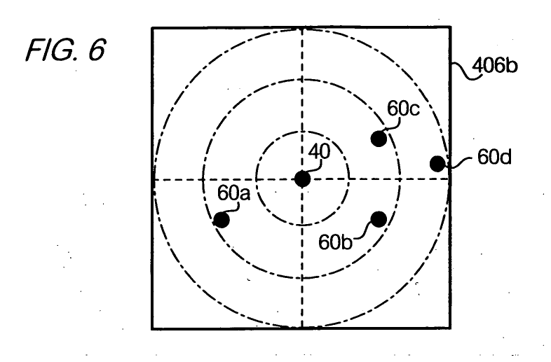

In location map 406b, current locations of wireless terminals 60 are plotted relative to direction and distance from the installed location of AP40 in meeting room 10, as illustrated in FIG. 6.

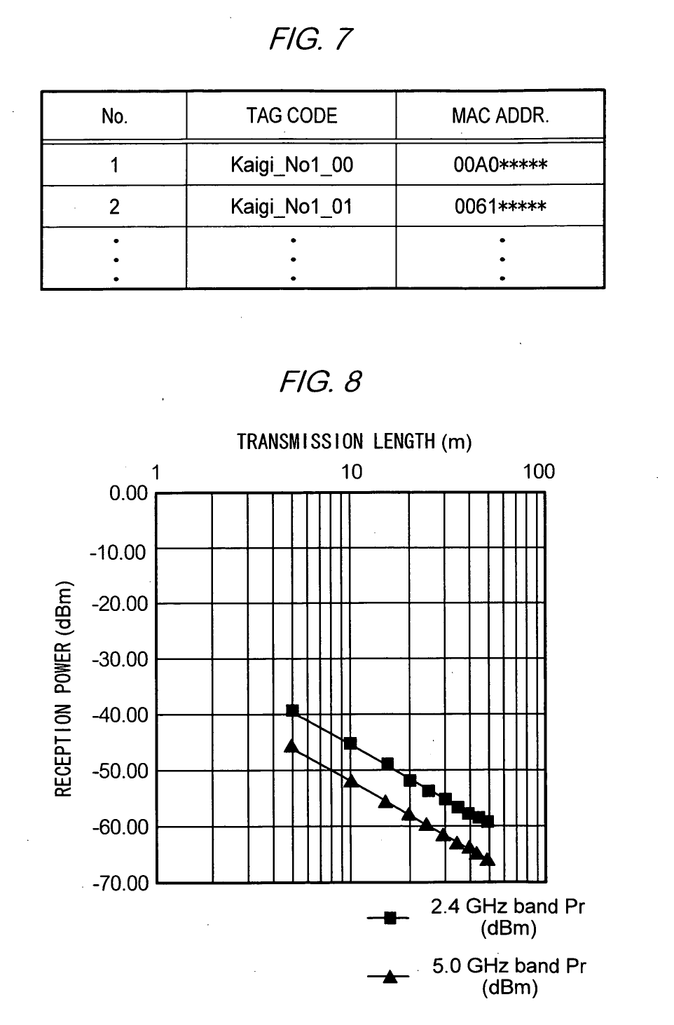

As illustrated in FIG. 7, management table 406c stores a MAC address as identification information of wireless terminal 60 connected to LAN70 via AP40, and the tag code dynamically assigned to the identification information of wireless terminal 60.

### B. Operations

### Preparing Service Area Information

In the present embodiment, service area information is prepared as follows:

When switched on, host computer 50 receives a plurality of template data 406a from AP40, and displays the received plurality of template data 406a on its display.

A meeting room administrator operates host computer 50 to select as a shape of service area an appropriate template data 406a which best fits the outline shape of meeting room 10. If no template data 406a fit the outline shape of meeting room 10, the person may operate host computer 50 to generate data indicating a shape of a service area, and store it as new template data.

After selecting or generating data indicating a shape of a service area, the administrator operates host computer 50 to input numerical data indicating a size of a service area. For example, when meeting room 10 is square and has 10 meter sides, the administrator inputs numerical data “10 m” indicating the length of the side.

The administrator operates host computer 50 to define the location of AP40 in the service area, namely, in meeting room 10, in the present embodiment.

Then, service area information, including the shape of the service area, numerical data indicating the size of the service area, and information on the location of AP40 in the service area is transmitted from host computer 50 to AP40, and stored in HD406 of AP40.

### Calculation of Transmission Power

On receiving from host computer 50 information on the shape and size of meeting room 10 and the information on the location of AP40 in meeting room 10, AP40 calculates a transmission power pattern of antenna 405a, the calculation being used to determine transmission power required for each direction to communicate with wireless terminals 60 located in meeting room 10, and stores the calculated transmission power pattern in HD406. More specifically, AP40 calculates a minimum transmission power for each direction required to steadily communicate with any wireless terminal 60 located in meeting room 10. In the present embodiment, the transmission power pattern is represented as two-dimensional. However, a three-dimensional transmission power pattern may be employed in a case where it is necessary to take into account a three-dimensional shape of a meeting room.

AP40 communicates with wireless terminal 60 located in meeting room 10 by using the transmission power required for the direction in which wireless terminal 60 is located, in accordance with the calculated transmission power pattern.

Accordingly, AP40 may communicate steadily with wireless terminal 60 located in meeting room 10, while AP40 may shorten a propagating distance of radio signals so that the radio signal overspill region outside meeting room 10 may be reduced. Namely, a surrounding area of meeting room 10, where the radio wave may be received, is reduced. Thus, security risks, such as theft of data transmitted from AP40 to wireless terminal 60, may be reduced.

AP40 may store in HD406 another transmission power pattern dedicated for measurement of current locations of wireless terminals 60.

### Measurement of Location of Wireless Terminal 60

AP40 broadcasts radio signals for measuring current locations of wireless terminals 60 in accordance with the transmission power pattern which is stored in HD406 for this measurement.

On receiving the broadcasted signal, wireless terminal 60 measures reception level Pr for the received signal, and transmits to AP40 a message including the measured reception level Pr.

On receiving the message from wireless terminal 60, AP40 determines the direction from AP40 to wireless terminal 60 on the basis of the most receive-sensitive direction of antenna 405a at the time of the reception, and calculates the distance from AP40 to wireless terminal 60 on the basis of the reception level Pr included in the received message and the transmission power of the broadcast signal in the determined direction. Thus, AP40 measures a location of wireless terminal 60.

Specifically, distance d from AP40 to wireless terminal 60 may be approximately calculated from reception level Pr at wireless terminal 60, and transmission power Pt at AP40, in accordance with equation (1).
Pr=Pt−Lp+Gt+Gr (1),
where Pr (dBm) is reception level at wireless terminal 60; Pt (dBm) is transmission power at AP40; Lp (dB) is loss in propagation; Gt (dBi) is transmission antenna gain at AP40; and Gr (dBi) is reception antenna gain at wireless terminal 60. In the present embodiment, LP may be practically approximated with Lb (fundamental propagation loss in a free space), which represents Lp in the case of an anisotropic antenna with zero gain. Lb is derived in accordance with equation (2).
Lb=20 log₁₀(4πdf/3×10⁸) (2),
where d (m) is distance from AP40 to wireless terminal 60; and f (Hz) is a frequency of radio signals.

The calculated distance d is correct only in an ideal case where no propagation loss arises. The propagation loss includes reflection of a radio wave from the surfaces of surrounding walls.

FIG. 8 illustrates relations between reception level Pr (dBm) at wireless terminal 60 and distance d(m) from AP40 to wireless terminal 60, in a case that f is set at either 2.4 GHz or 5.0 GHz, Pt is set at 10 dBm, Gt is set at 2.2 dB, and Gr is set at 2.2 dBi. In a real situation where various propagation losses occur including reflections of radio wave, reception level Pr of wireless terminal 60 becomes smaller than the value shown in FIG. 8. In the following example, Pr, Gt, Gr are set to 10, 2.2, 2.2, respectively, in equation (1).

More specifically, CPU401 reads the transmission power pattern stored in HD406, generates a command message for instructing the transmission of a signal for measuring a location of wireless terminal 60 by including the transmission power pattern, and transmits the command message to wireless communication unit 405.

When receiving the command message, wireless communication unit 405 controls the transmission power and emission direction of radio signals from antenna 405a in accordance with the transmission power pattern included in the received command message. Accordingly, radio signals for measuring current locations of wireless terminals 60 propagate from antenna 405a within a prescribed area around the prescribed directions set by 60 degree intervals as illustrated in FIG. 4.

On receiving via wireless communication unit 405 a terminal reception message including reception level at wireless terminal 60 of the signal for measuring a location, CPU401 determines direction and calculates distance of wireless terminal 60 relative to AP40 on the basis of the reception level included in the terminal reception message and the transmission power and transmission direction of the signal for measuring the location. Thus, a current location of wireless terminal 60 is measured.

A similarly constructed antenna to the antenna 405a may be applied for other known methods of measuring the location of wireless terminal 60.

AP40 may also calculate the transmission power of wireless terminal 60 by taking account of the location of wireless terminal 60 in meeting room 10 and antenna characteristics of wireless terminal 60, and notify the calculated transmission power to wireless terminal 60. Then, wireless terminal 60 transmits radio signals with the notified transmission power. According to this modification, the spillover of the signals transmitted from wireless terminal 60 outside meeting room 10 may be reduced.

Furthermore, host computer 50 may pre-store transmission power calculated for AP40 or wireless terminal 60 and notify them to AP40 or wireless terminal 60, respectively.

### Initial Connection to LAN70

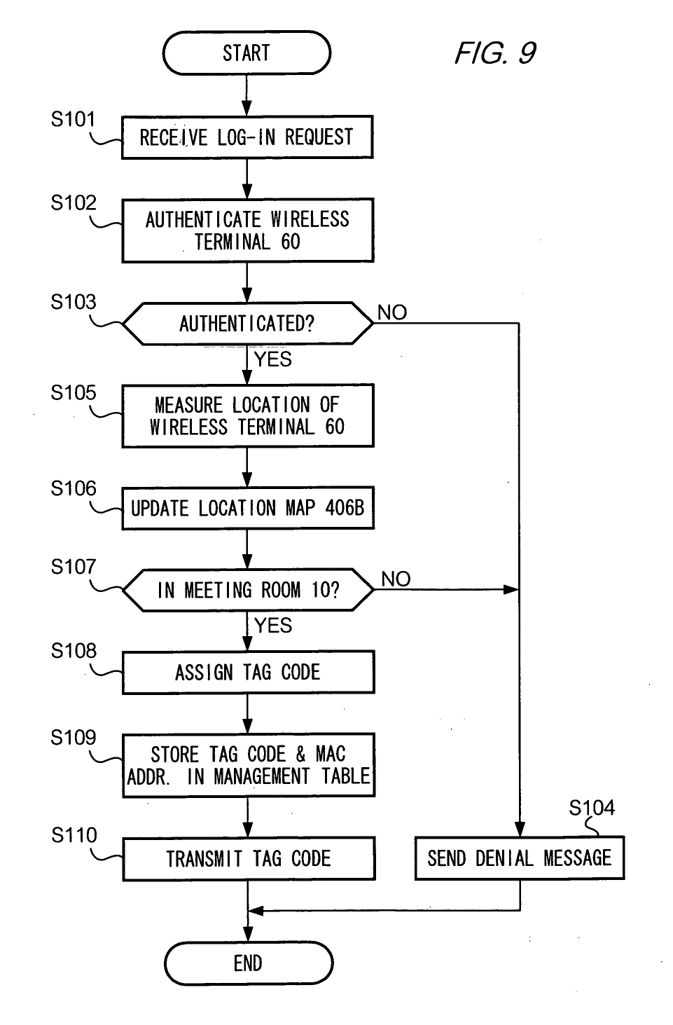

FIG. 9 is a flowchart illustrating operations of AP40 when wireless terminal 60 requests AP40 to connect to LAN70. In the present embodiment, AP40 pre-stores in HD406 a meeting-specific password for each meeting and MAC addresses (or nicknames) of wireless terminals 60 which are entitled to join each meeting.

As illustrated in FIG. 9, on receiving a connection request to LAN70 from wireless terminal 60 (Step S101), AP40 compares the SSID, password, nickname and MAC address included in the request and the corresponding entity stored in HD406, so as to authenticate wireless terminal 60 (Step S102). In the present example, wireless terminal 60 is not authenticated when nickname, MAC Address or password included in the received connection request differ from the corresponding entity stored in HD406.

When wireless terminal 60 is not authenticated (Step S103:NO), AP40 transmits to wireless terminal 60 a message indicating that connection to LAN70 is prohibited (Step S104), and terminates the operations illustrated in FIG. 9.

When wireless terminal 60 is authenticated (Step S103:YES), AP40 measures a location of wireless terminal 60 (Step S105), and plots the currently measured location of wireless terminal 60 in location map 406b (Step S106).

AP40 determines whether wireless terminal 60 is located in meeting room 10 by taking account of service area information stored in HD406 (shape and size of meeting room 10, the location of AP40 in meeting room 10) (Step S107).

In a case of determining that wireless terminal 60 is located outside meeting room 10 (Step S107:NO), AP40 transmits to wireless terminal 60 a message indicating that a connection to LAN70 is prohibited (Step S104), and terminates the operations illustrated in FIG. 9 without connecting to LAN70.

In a case of determining that wireless terminal 60 is located in meeting room 10 (Step S107:YES), AP40 assigns the wireless terminal 60 a new tag code (Step S108), and stores the newly assigned tag code in management table 406c corresponding to the identification information unique to the wireless terminal (Step S109), and transmits the newly assigned tag code to wireless terminal 60 (Step S110). In the present example, a MAC address is used as identification information.

Thus, wireless terminal 60 connects to LAN70 via AP40.

### Operations after Initial Connection to LAN70

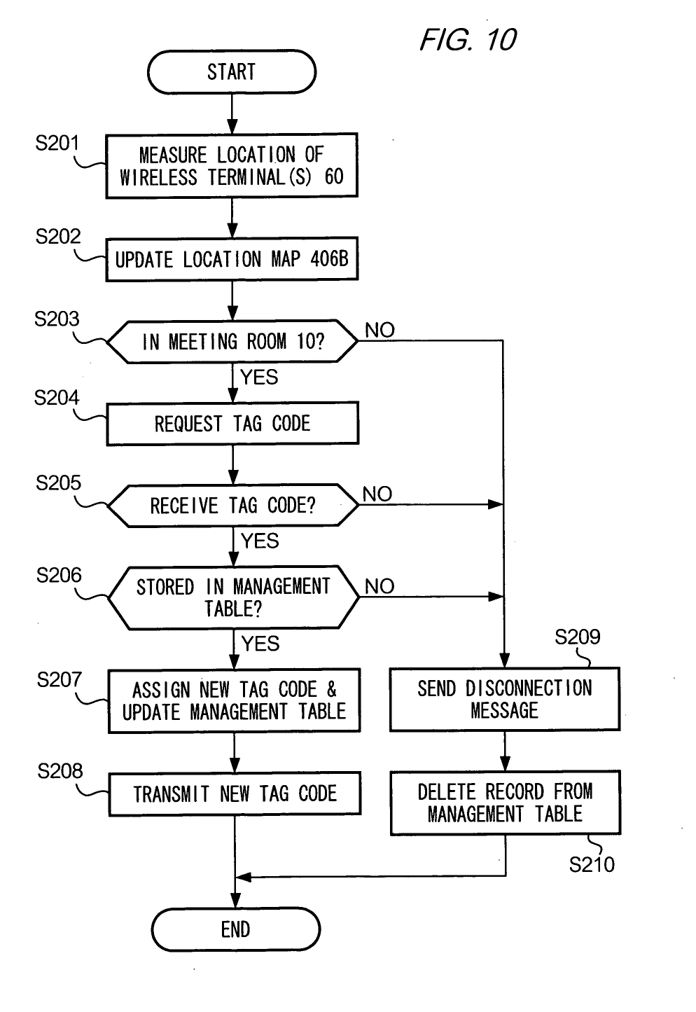

FIG. 10 is a flowchart illustrating operations of AP40 after initial connection to LAN70. AP40 monitors whether wireless terminal 60 connected to LAN70 via AP40 is located inside/outside meeting room 10.

Specifically, CPU401 of AP40 performs the operations illustrated in FIG. 10 periodically; for example, every three seconds.

As illustrated in FIG. 10, AP40 measures current locations of all wireless terminals 60 registered in management table 406c (Step S201). AP40 updates locations of wireless terminals 60 stored in location map 406b with the current locations of wireless terminals 60(Step S202).

AP40 determines whether each wireless terminal 60 is located inside or outside meeting room 10 by using service area information, such as the shape or the size of meeting room 10, or the location of AP40 within meeting room 10 (Step S203).

When determining that wireless terminal 60 is located inside meeting room 10 (Step S203:YES), AP40 transmits to wireless terminal 60 a request of notification, which requests wireless terminal 60 to transmit AP40 identification information and a tag code assigned to the wireless terminal 60(Step S204). When receiving from wireless terminal 60 the identification information and the tag code within a prescribed time (Step S205:YES), AP40 compares the received tag code and the tag code stored in management table 406c corresponding to the identification information of the wireless terminal 60(Step S206).

When the received tag code agrees with the stored one (Step S206:YES), AP40 assigns a new tag code to the wireless terminal 60, stores the new tag code in management table 406c corresponding to the identification information of wireless terminal 60 (Step S207), and transmits the new tag code to the wireless terminal 60 (Step S208). In the present example, a MAC address is used for identification information of wireless terminal 60.

Furthermore, the new tag code may be scrambled before it is transmitted to wireless terminal 60 in Step S208. According to this modification, a connection to LAN70 from a wireless terminal 60 which transmits false identification information may be disconnected.

When determining that wireless terminal 60 is located outside meeting room 10 (Step S203:NO), a message of compulsory disconnection is transmitted to wireless terminal 60(Step S209), and the record of wireless terminal 60 is deleted from management table 406c(Step S210).

Thus, the connection to LAN70 from wireless terminal 60 via AP40 is disconnected, when wireless terminal 60 moves out of meeting room 10.

### Closing Operations

At the end of a meeting, AP40 receives from host computer 50 a notification that the meeting has ended.

On receiving the notification, AP40 transmits to all wireless terminals 60 registered in management table 406c a message notifying compulsory disconnection, and deletes records of all wireless terminals 60 from management table 406c.

AP40 may receive the notification of the end of the meeting from a specific wireless terminal 60; for example, that which the chairperson of the meeting is using.

### C. Modifications

(1) When receiving a connection request from wireless terminal 60 at Step S102, AP40 may determine whether the wireless terminal 60 is located in the vicinity of meeting room 10 and authenticate the wireless terminal 60 at Step S103 and subsequent steps. Specifically, AP40 transmits a request for an acknowledgement message to a wireless terminal 60, while controlling the coverage area of radio wave. AP40 determines whether it has received an acknowledgement message from wireless terminal 60 within a prescribed time. Only in a case of receiving the acknowledgement message within the prescribed time, AP40 executes the process at Step S103 and subsequent steps. Accordingly, AP40 need not execute the process at Step S103 and subsequent steps of handling an unintentional connection request from wireless terminals located outside meeting room 10.

(2) AP40 may disconnect from a wireless terminal 60 to LAN70, only in a case of determining multiple successive times that the wireless terminal 60 is located outside meeting room 10. Namely, AP40 may disconnect the connection from a wireless terminal 60 to LAN70, only in a case of determining that the wireless terminal 60 is located for longer than a prescribed time (for example, 10 seconds) outside meeting room 10. Accordingly, disconnections due to misrecognition that wireless terminal 60 is located outside meeting room 10 may be reduced. Such misrecognition may be caused by, for example, noise interference.

(3) Longitude/latitude information may be used when defining a service area. Furthermore, in a case that AP40 has a GPS (Global Position Sensing) receiving unit, the location of AP40 in service area may be automatically defined on the basis of the absolute location of AP40 measured by the GPS receiving unit.

(4) The computer program may be downloaded from a network and installed in a computer to cause the computer to execute the processes according to the present invention. The computer program may be stored and distributed in any computer-readable media.

1. A base station, comprising:
a wireless communication unit for wirelessly communicating with a wireless terminal;
means for connecting to and disconnecting from a wireless network;
a storage unit for storing service area information defining a service area around the base station, the wireless terminal located inside the service area being allowed to connect to the network via the wireless communication unit of the base station;
a measuring unit for measuring the location of a wireless terminal;
first determining means for determining whether a wireless terminal is located in the service area around the base station on the basis of the location of the wireless terminal measured by the measuring unit;
connecting means for connecting a wireless terminal to the network via the base station in a case that the wireless terminal is determined by the first determining means to be located in the service area around the base station;
monitoring means for monitoring the location of the wireless terminal which is connected to the network by the connecting means;
second determining means for determining whether the wireless terminal monitored by the monitoring means is located inside the service area; and
means for disconnecting a connection from a wireless terminal to the network via the wireless communication unit of the base station in a case that the wireless terminal is determined by the second determining means to be located outside the service area.

2. The base station according to claim 1, further comprising:
means for setting-up transmitting characteristics of the wireless communication unit of the base station on the basis of the service area information stored in the storage unit.

3. The base station according to claim 2, wherein
the wireless communication unit transmits a message to a wireless terminal in accordance with the transmitting characteristics set-up by the setting-up means, and
the measuring unit measures the location of a wireless terminal only in a case of receiving a response to the message from the wireless terminal within a predetermined time.

4. A wireless communication network comprising the base station according to claim 1.

5. A method, performed by a base station, comprising:
measuring a location of a wireless terminal;
first determining whether a wireless terminal is located in a service area of the base station on the basis of the location of the wireless terminal measured in the measuring step;
connecting a wireless terminal to a network via the base station in a case that the wireless terminal is determined to be located in the service area in the first determining step;
monitoring the location of the wireless terminal connected to the network in the connection step;
second determining whether a wireless terminal is located in the service area of the base station on the basis of the location of the wireless terminal monitored in the monitoring step;
disconnecting a connection from a wireless terminal to the network via the base station in a case that the wireless terminal is determined to be located outside the service area in the second determining step.

6. A computer program product for enabling a computer to cause a base station to perform:
measuring a location of a wireless terminal;
first determining whether a wireless terminal is located in a service area of the base station on the basis of the location of the wireless terminal measured in the measuring process;
connecting a wireless terminal to a network via the base station in a case that the wireless terminal is determined to be located in the service area in the first determining process;
monitoring the location of the wireless terminal connected in the connecting process;
second determining whether a wireless terminal is located in the service area of the base station on the basis of the location of the wireless terminal monitored in the monitoring process;
disconnecting a connection from a wireless terminal to the network via the base station in a case that the wireless terminal is determined to be located outside the service area in the second determining process.

7. A computer-readable storage medium storing the computer program product according to claim 6.
